(19) United States
(12) Patent Application Publication
(10) Pub. No.: US 2005/0199541 A1
(43) Pub. Date: Sep. 15, 2005

(54) Fuel filter with fuel-activating function

(76) Inventor: Shih-Siang Jheng, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/799,666

(22) Filed: Mar. 15, 2004

(51) Int. Cl. B01D 35/28

(52) U.S. Cl. 210/435; 250/436; 250/435; 422/186

(57) ABSTRACT

A fuel filter includes a housing, a filtering element mounted in the housing, the filtering element including a hollow central portion surrounded by a filtering arrangement, and a material for emitting far-infrared rays for activating fuel molecules passing through the filtering filter. The fuel molecules are activated by far-infrared rays when the fuel is passing through the filtering arrangement that removes undesired substances from the fuel. The combustion efficiency of the resultant fuel/air mixture in a combustion chamber of a cylinder of a vehicle is excellent.

### BACKGROUND OF THE INVENTION

1. Field of the Invention

The present invention relates to a fuel filter. In particular, the present invention relates to a fuel filter for activating fuel while filtering fuel.

2. Description of the Related Art

A fuel filter is mounted between a fuel tank and a carburetor for removing undesired substances from fuel before it enters the carburetor, thereby improving the combustion efficiency and avoiding damage to the engine parts and the carburetor. The filtered fuel is atomized and mixed with air in the carburetor, and the fuel/air mixture is guided into a combustion chamber of a cylinder for combustion. The combustion efficiency largely depends on the fuel/air ratio. The air is filtered by an air filter and enters a suction tube of the carburetor. The filtered fuel is sucked into the suction tube under the action of a negative pressure created by the Bernoulli's law. In particular, the fuel particles are mixed with the air only in the suction tube. No further mixing action occurs to the fuel/air mixture in a chamber in the carburetor connected to the combustion chamber of the cylinder. The present invention is intended to provide an improved fuel filter to provide assistance in obtaining a well-mixed fuel/air mixture.

### SUMMARY OF THE INVENTION

In accordance with an aspect of the present invention, a fuel filter includes a housing, a filtering element mounted in the housing, the filtering element including a hollow central portion surrounded by a filtering arrangement, and means for emitting far-infrared rays for activating fuel molecules passing through the filtering filter.

In a first embodiment of the invention, the means for emitting far-infrared rays includes a core mounted in the hollow central portion and made of a material that emits far-infrared rays.

In a second embodiment of the invention, the means for emitting far-infrared rays includes a sleeve mounted around the filtering arrangement and made of a material that emits far-infrared rays.

In a third embodiment of the invention, the means for emitting far-infrared rays includes a cup mounted around the filtering arrangement and made of a material that emits far-infrared rays.

The fuel molecules are activated by far-infrared rays when the fuel is passing through the filtering arrangement that removes undesired substances from the fuel. The active fuel molecules are efficiently mixed with the air. The combustion efficiency of the resultant fuel/air mixture in a combustion chamber of a cylinder of a vehicle is excellent. A fuel-saving effect is obtained, the vehicle performance is improved, the engine operation is smoother, and the life of the engine is prolonged.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a fuel filter in accordance with the present invention.

FIG. 2 is a perspective view of the fuel filter in FIG. 1.

FIG. 3 is an exploded perspective view of a second embodiment of the fuel filter in accordance with the present invention.

FIG. 4 is a perspective view of the fuel filter in FIG. 3.

FIG. 5 is an exploded perspective view of a third embodiment of the fuel filter in accordance with the present invention.

FIG. 6 is a perspective view of the fuel filter in FIG. 5.

FIG. 7 is a schematic view of a system for mixing fuel and air.

### DETAILED DESCRIPTION OF THE PREFERRED EMBODIMENTS

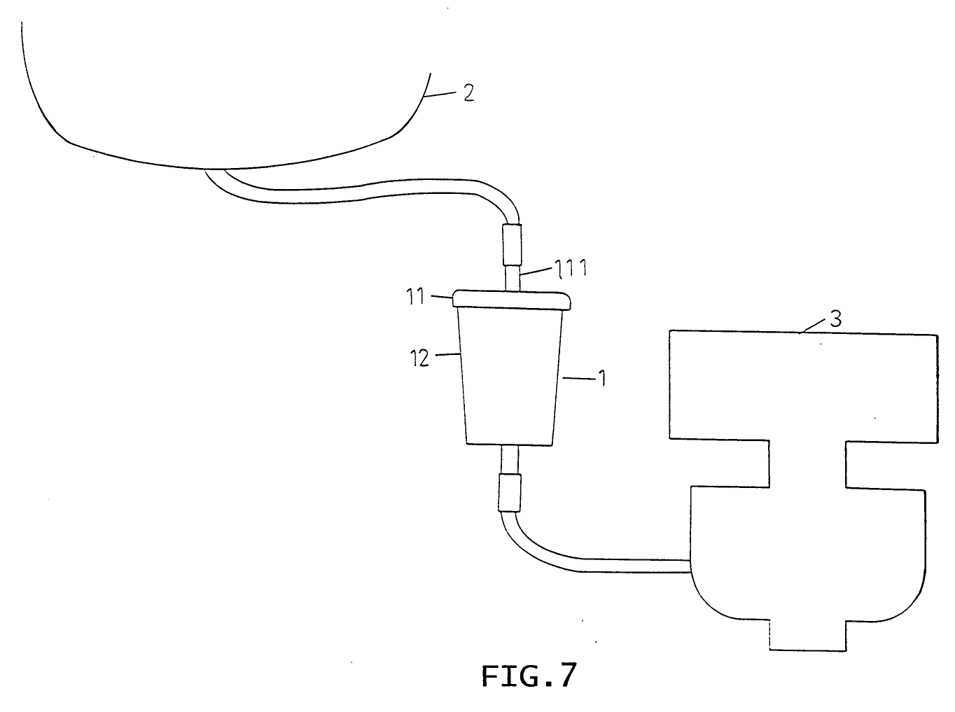

Referring to FIG. 7, a system for mixing fuel and air includes a fuel tank 2, a carburetor 3, and a fuel filter 1 in accordance with the present invention for filtering fuel from the fuel tank 2 before the fuel enters the carburetor 3.

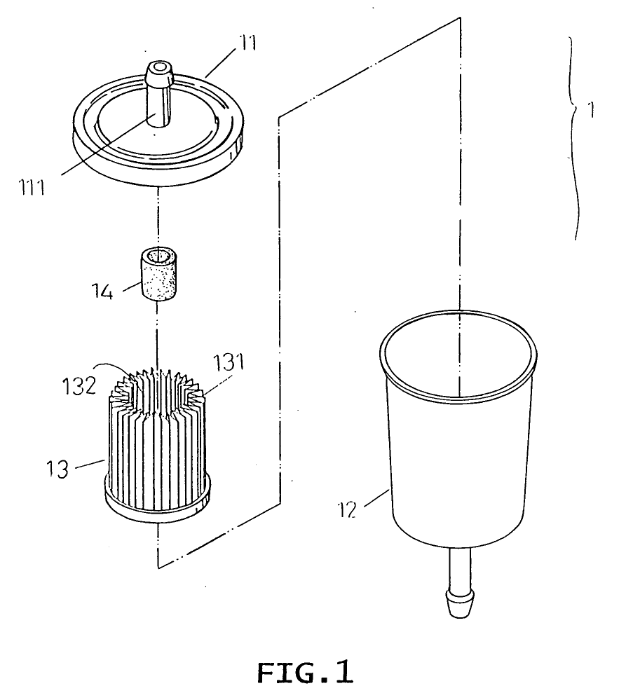

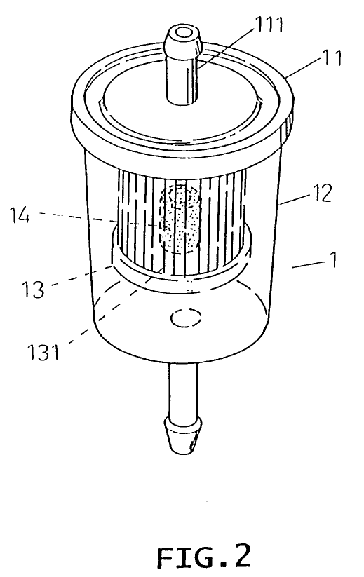

Referring to FIGS. 1 and 2, the fuel filter 1 in accordance with the present invention comprises a housing 12, a filtering element 13 mounted in the housing 12, a cap 11 for closing an open end (not labeled) of the housing 12, and means for emitting far-infrared rays. The filtering element 13 includes a hollow central portion 132 surrounded by a filtering arrangement 131. The fuel filter 1 is connected to the fuel tank 2 by a tube 111. The fuel enters the carburetor 3 after passing through the fuel filter 1.

In a first embodiment of the fuel filter shown in FIGS. 1 and 2, the means for emitting far-infrared rays includes a core 14 mounted in the hollow central portion 132 and made of a material that emits far-infrared rays.

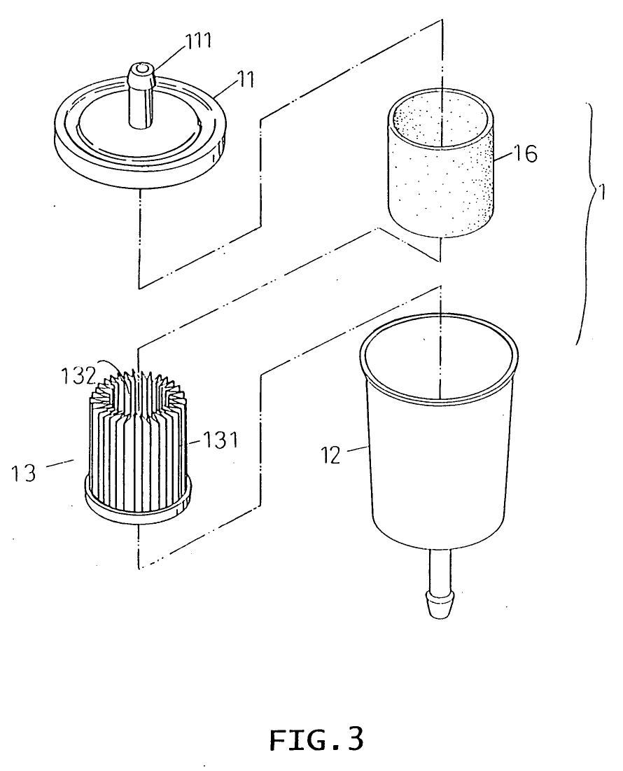

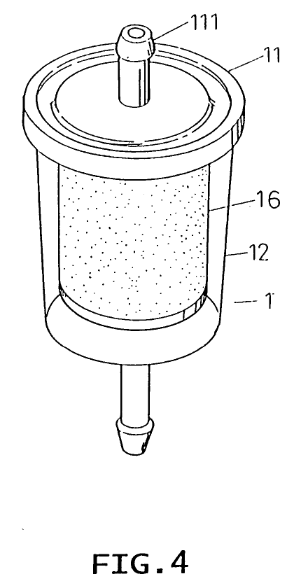

In a second embodiment of the fuel filter shown in FIGS. 3 and 4, the means for emitting far-infrared rays includes a sleeve 16 mounted around the filtering arrangement 131 and made of a material that emits far-infrared rays.

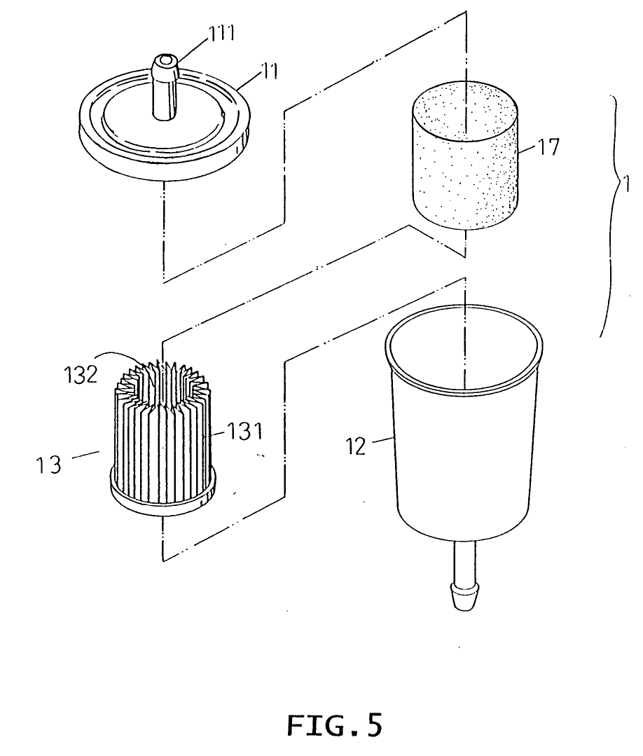

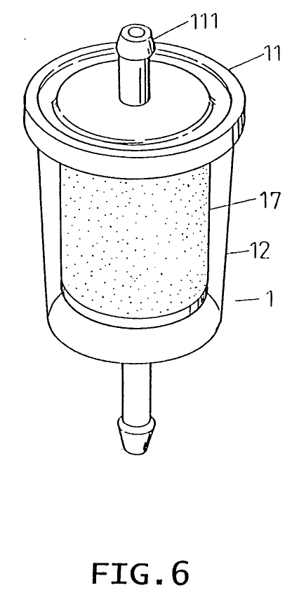

In a third embodiment of the fuel filter shown in FIGS. 5 and 6, the means for emitting far-infrared rays includes a cup 17 mounted around the filtering arrangement 131 and made of a material that emits far-infrared rays.

It is well known that far-infrared rays having a wavelength of 8-14 microns are advantageous to growth of animals and plants. Thus, the fuel molecules are activated by the far-infrared rays when the fuel is passing through the filtering arrangement 131 that removes undesired substances from the fuel. The active fuel molecules are efficiently mixed with the air. The combustion efficiency of the resultant fuel/air mixture in a combustion chamber of a cylinder of a vehicle is excellent, as the activated fuel molecules after atomization and mixing with the air may efficiently react with the air. A fuel-saving effect is obtained, the vehicle performance is improved, the engine operation is smoother, and the life of the engine is prolonged.

Although the invention has been explained in relation to its preferred embodiment, it is to be understood that many other possible modifications and variations can be made without departing from the scope of the invention as hereinafter claimed.

1. A fuel filter comprising:
a housing;
a filtering element mounted in the housing, the filtering element including a hollow central portion surrounded by a filtering arrangement; and
means for emitting far-infrared rays for activating fuel molecules passing through the filtering filter.

2. The fuel filter as claimed in claim 1, wherein said means for emitting far-infrared rays includes a core mounted in the hollow central portion and made of a material that emits far-infrared rays.

3. The fuel filter as claimed in claim 1, wherein said means for emitting far-infrared rays includes a sleeve mounted around the filtering arrangement and made of a material that emits far-infrared rays.

4. The fuel filter as claimed in claim 1, wherein said means for emitting far-infrared rays includes a cup mounted around the filtering arrangement and made of a material that emits far-infrared rays.
